(19) United States
(12) Patent Application Publication
(10) Pub. No.: US 2011/0143320 A1
(43) Pub. Date: Jun. 16, 2011

(54) HEV BRAKE PEDAL SIMULATOR AIR GAP FILLER SYSTEM AND METHOD

(76) Inventors: John McCormick, Milford, MI (US); Peter Francis Worrel, Troy, MI (US); Daniel A. Gabor, Canton, MI (US); Dale Scott Crombez, Livonia, MI (US); Clement Newman Sagan, Dearborn, MI (US)

(21) Appl. No.: 12/845,909

(22) Filed: Jul. 29, 2010

(51) Int. Cl. G09B 19/16

(52) U.S. Cl. 434/62

(57) ABSTRACT

A brake pedal simulator air gap filler system includes a brake pedal, a pedal feel simulator engaged by the brake pedal, a pedal push rod engaged by the brake pedal, a master cylinder/booster push rod spaced-apart from the pedal push rod, an air gap between the pedal push rod and the master cylinder/booster push rod, a master cylinder/booster engaged by the master cylinder/booster push rod and an air gap filling apparatus having an air gap filling head in adjacent proximity to the air gap and adapted to selectively engage and disengage the air gap.

### FIELD OF THE INVENTION

The disclosure generally relates to regenerative braking systems in hybrid electric vehicles (HEVs, FHEVs, PHEVs, BEVs, FCEVs). More particularly, the disclosure relates to an HEV brake pedal air gap filler system and method which fills an air gap between a Brake pedal push rod and/or arm and a master cylinder push rod (or input rod) to impart braking to an HEV in the event that brake system control of the active booster is compromised during regenerative braking thereby affecting brake pedal feel.

### BACKGROUND OF THE INVENTION

In regenerative braking systems, where independent force control of the hydraulic brake system is required, the capability of the active booster function to provide the force which is required to allow flow of ambient air into the booster and induce vacuum boost within a desired period of time may be reduced under some conditions. The system performance may become unacceptably slow and result in a fall back level that changes the brake pedal feel and increases the brake travel distance which is required to stop the vehicle. The changes in brake pedal feel and travel distance are due to the presence of an air gap between the pedal push rod/arm and the master cylinder/booster push rod (or input rod). Under normal conditions, the space in the air gap is used during series regenerative braking. Under conditions in which the active booster function is compromised, series regenerative braking is disabled and the pedal feel simulator is shut off or bypassed.

Therefore, an HEV brake pedal simulator air gap filler system and method which fills an air gap between a brake pedal arm and a master cylinder push rod to impart braking to an HEV in the event that a pedal feel simulator is compromised during regenerative braking is needed.

### SUMMARY

The disclosure is generally directed to a brake pedal simulator air gap filler system. An illustrative embodiment of the system includes a brake pedal, a pedal feel simulator engaged by the brake pedal, a pedal push rod engaged by the brake pedal, a master cylinder/booster push rod (or input rod) spaced-apart from the pedal push rod, an air gap between the pedal push rod and the master cylinder/booster push rod, a master cylinder/booster engaged by the master cylinder/booster push rod and an air gap filling apparatus having an air gap filling head in adjacent proximity to the air gap and adapted to selectively engage and disengage the air gap.

In some embodiments, the brake pedal simulator air gap filler system may include an electronic control unit; a brake pedal; a pedal feel simulator engaged by the brake pedal and interfacing with the electronic control unit; a pedal push rod engaged by the brake pedal; a master cylinder/booster push rod spaced-apart from the pedal push rod; an air gap between the pedal push rod and the master cylinder/booster push rod; a master cylinder/booster engaged by the master cylinder/booster push rod and interfacing with the electronic control unit; and an air gap filling apparatus having an air gap filling head in adjacent proximity to the air gap and interfacing with the electronic control unit. The electronic control unit may be adapted to detect a condition affecting the master cylinder/booster and responsively inactivate the pedal feel simulator and cause engagement of the air gap filling head of the air gap filling apparatus with the air gap.

The disclosure is further generally directed to an HEV brake pedal simulator air gap filler method. An illustrative embodiment of the method includes positioning an air gap filling head in adjacent proximity to an air gap between a pedal push rod and a master cylinder/booster push rod of a hybrid electric vehicle braking system; detecting a condition affecting a master cylinder/booster of the braking system; disabling a series regenerative braking mode and a pedal feel simulator of the braking system; extending the air gap filling head into the air gap; and extending the master cylinder/booster push rod into a master cylinder/booster of the braking system through the pedal push rod and the air gap filling head.

### BRIEF DESCRIPTION OF THE DRAWINGS

The disclosure will now be made, by way of example, with reference to the accompanying drawings, in which:

FIG. 1 is a partially schematic side view of an illustrative embodiment of the HEV brake pedal simulator air gap filler system, with the air gap filling apparatus of the system deployed in a gap-disengaging position;

FIG. 2 is a partially schematic side view of the HEV brake pedal simulator air gap system, with the air gap filling apparatus of the system deployed in a gap-engaging and filling position;

FIG. 3 is a schematic block diagram of an illustrative embodiment of the HEV brake pedal simulator air gap filler system;

FIG. 4 is a schematic block diagram which illustrates exemplary operation of the HEV brake pedal simulator air gap filler system; and

FIG. 5 is a block diagram of an illustrative embodiment of an HEV brake pedal simulator air gap filler method.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims. Furthermore, there is no intention to be bound by any expressed or implied theory presented in the preceding technical field, background, brief summary or the following detailed description.

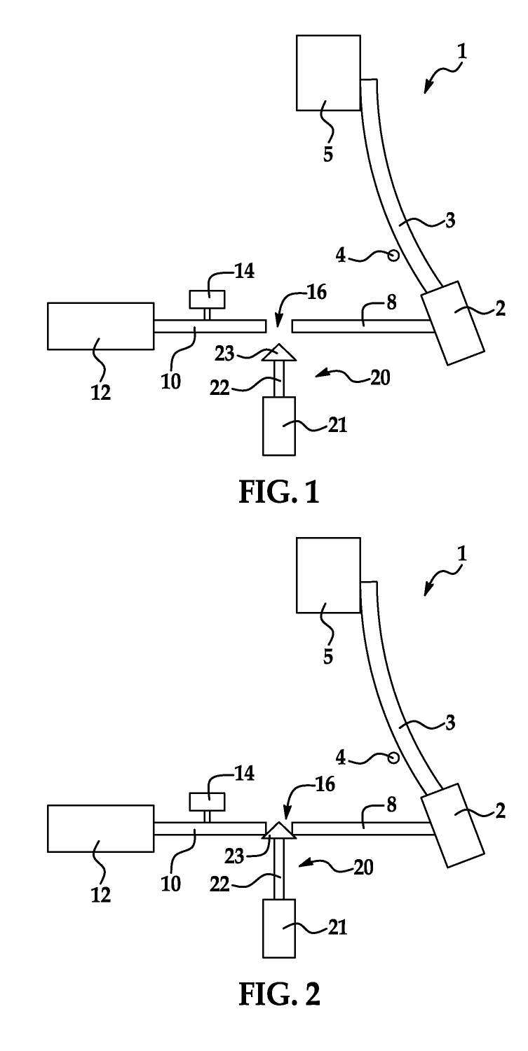

Referring initially to FIGS. 1 and 2, an illustrative embodiment of the HEV brake pedal simulator air gap filler system, hereinafter system, is generally indicated by reference numeral 1. The system 1 may be applicable to hybrid elective vehicles (HEVs) and may include a brake pedal 2 on an elongated brake pedal shaft 3. A brake pedal position sensor 4 may be engaged by the brake pedal shaft 3 to sense a position of the brake pedal shaft 3 from a home position through a fully depressed position of the brake pedal 2. A pedal feel simulator 5 may be engaged by the brake pedal shaft 3. The pedal feel simulator 5 may have a conventional design which imparts a brake pedal feel to the brake pedal 2 as the brake pedal 2 is depressed (not shown) by the foot which changes the airgap distance of an operator of the HEV during braking of the HEV, as is known by those skilled in the art.

A pedal push rod 8 may extend from the brake pedal 2. In the event that a pedal push rod does not exist, a gap filling device extends from pedal arm to master cylinder input rod. A master cylinder/booster push rod 10 may be axially aligned with and disposed in spaced-apart relationship with respect to the pedal push rod 8. An air gap 16 may separate the master cylinder/booster push rod 10 from the pedal push rod 8. The master cylinder/booster push rod 10 may engage a master cylinder/booster 12. An active booster solenoid valve provides assist to input rod movement to provide power brake 14 may engage the master cylinder/booster push rod 10.

An air gap filling apparatus 20 may be disposed in adjacent proximity to the air gap 16 between the pedal push rod 8 and the master cylinder/booster push rod 10 for purposes which will be hereinafter described. The air gap filling apparatus 20 may include a gap filling head actuator 21 which may be a solenoid, for example and without limitation. An actuator shaft may be engaged for extension and retraction by the gap filling head actuator 21. An air gap filling head 23 may be on the distal or extending end of the actuator shaft 22. In some embodiments, the air gap filling head 23 may have a generally wedge-shaped configuration, as shown. Accordingly, as shown in FIG. 1, the actuator shaft 22 may be disposed in a retracted configuration in the gap filling head actuator 21 in which the air gap filling head 23 disengages the air gap 16. As shown in FIG. 2, responsive to operation of the gap filling head actuator 21, the actuator shaft 22 may be extended from the gap filling head actuator 21 such that the air gap filling head 23 engages and fills or bridges the air gap 16 for purposes which will be hereinafter described.

Referring next to FIG. 3, a schematic block diagram of an illustrative embodiment of the HEV brake pedal simulator air gap filler system 1 is shown. The system 1 may include an ECU (Electronic Control Unit) 26. The pedal position sensor 4, the pedal feel simulator 5, the electric master cylinder push rod actuator 14 and the air gap filling apparatus 20 may interface with the ECU 26. At least one motor 28 of the HEV may additionally interface with the ECU 26.

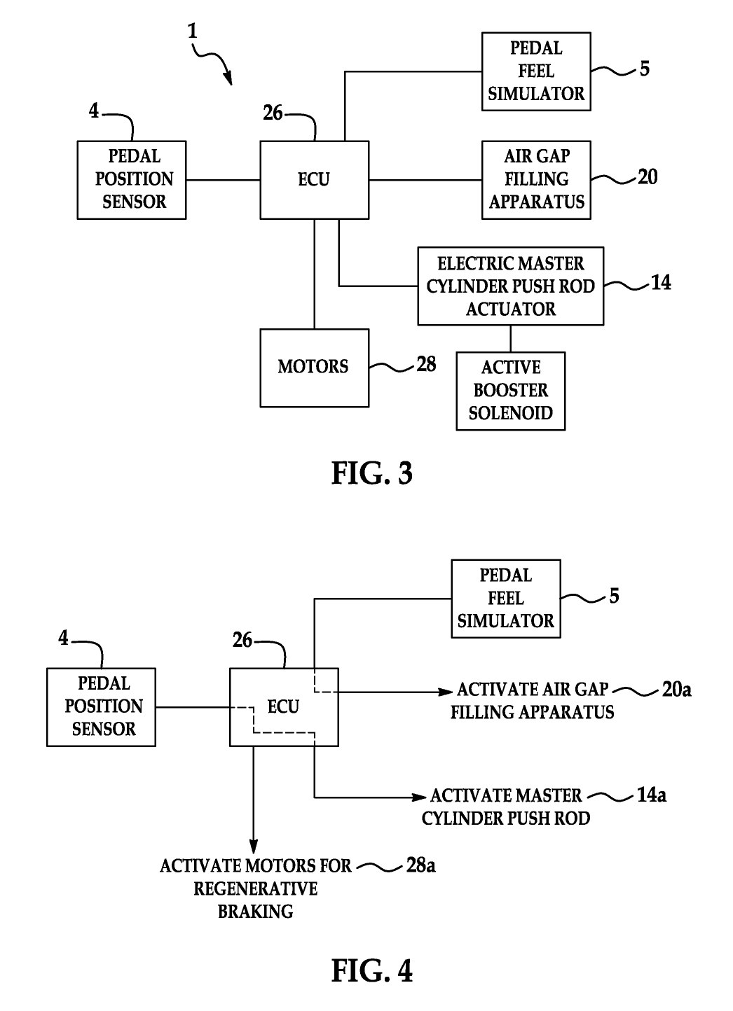

During braking of the HEV, an operator (not shown) of the HEV depresses the brake pedal 2. The ECU 26 may continually receive input on the position of the brake pedal 2 (FIGS. 1 and 2) from the pedal position sensor 4. During braking, the ECU 26 may operate in a series regenerative braking mode, a series regenerative braking supplemented by hydraulic braking mode or a hydraulic mode. In the series regenerative braking mode, the ECU 26 activates the motor or motors 28 (FIG. 3) of the HEV for regenerative braking, as indicated by reference numeral 28a in FIG. 4. This motor or motors 28 provides vehicle deceleration in lieu of the hydraulic brake actuation. The pedal push rod 8 traverses the air gap 16 and air (not shown) is forced from the air gap 16 and used in regenerative braking. The pedal feel simulator 5 may impart a brake pedal feel to the brake pedal 2 by exerting resistance to the brake pedal shaft 3 in the conventional manner providing conventional brake feel. The actuator shaft 22 remains retracted into the gap filling head actuator 21 of the air gap filling apparatus 20 and the air gap filling head 23 remains disengaged from the air gap 16, as shown in FIG. 1.

In the series regenerative braking supplemented by hydraulic braking mode, the ECU 26 activates the motor or motors (FIG. 3) of the HEV for regenerative braking, as indicated by reference numeral 28a in FIG. 4. The pedal push rod 8 traverses the air gap 16 and air (not shown) is forced from the air gap 16 and used in regenerative braking. However, the pedal push rod 8 does not bear on the master cylinder/booster push rod 10. Instead, the ECU 26 activates the electric master cylinder push rod actuator 14 (as indicated by reference numeral 14a in FIG. 4), which in turn pushes the master cylinder/booster push rod 10 into the master cylinder/booster 12. The master cylinder/booster 12 actuates the hydraulic brakes (not shown) of the HEV. The pedal feel simulator 5 may impart a brake pedal feel to the brake pedal 2 by exerting resistance to the brake pedal shaft 3. The actuator shaft 22 remains retracted into the gap filling head actuator 21 of the air gap filling apparatus 20 and the air gap filling head 23 remains disengaged from the air gap 16, as shown in FIG. 1.

Under some circumstances, the ECU 26 may determine that conditions (such as ambient cold conditions, for example and without limitation) exist which may compromise the active booster function of the master cylinder/booster 12. Accordingly, the ECU 26 may disable the series regen braking function and the pedal feel simulator 5. Upon depression of the brake pedal 2, the ECU 26 actuates the air gap filling apparatus (as indicated by reference numeral 20a in FIG. 4). The actuator shaft 22 is extended from the gap filling head actuator 21 until the air gap filling head 23 fills or bridges the air gap 16, as shown in FIG. 2. Therefore, the pedal push rod 8 pushes the air gap filling head 23 of the air gap filling apparatus 20, which in turn pushes the master cylinder/booster push rod 10 into the master cylinder/booster 12. The master cylinder/booster 12 operates the hydraulic brakes of the HEV. Therefore, the feel and travel distance of the brake pedal 2 simulate the brake pedal feel and travel of a conventional non-hybrid boosted brake system as the hydraulic brakes slow or stop the HEV.

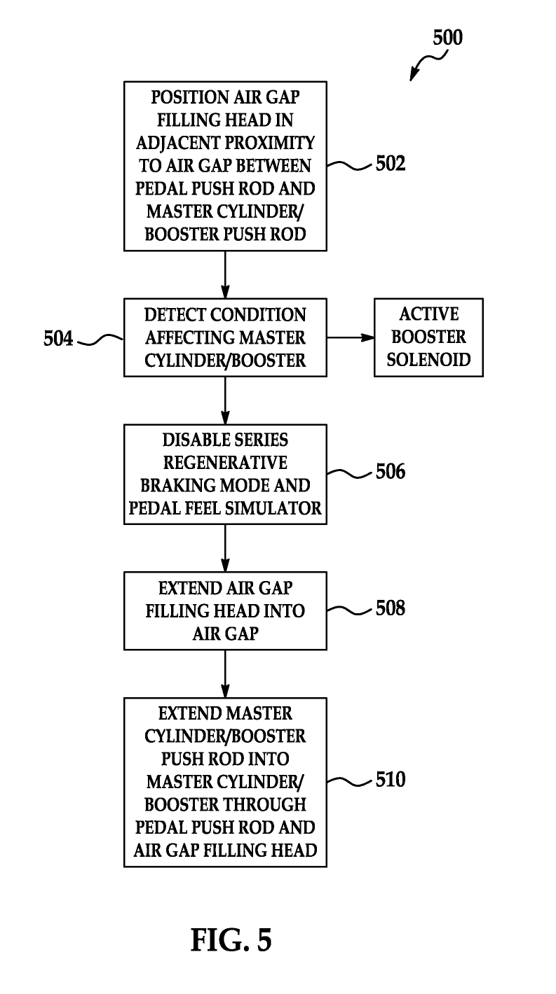

Referring next to FIG. 5, a block diagram 500 of an illustrative embodiment of an HEV brake pedal simulator air gap filler method is shown. In block 502, an air gap filling head is positioned in adjacent proximity to an air gap between a pedal push rod and a master cylinder/booster push rod of an HEV braking system. In block 504, a condition affecting a master cylinder/booster of the HEV braking system is detected. In some embodiments, the condition affecting the master cylinder/booster may be a cold condition which may compromise the efficacy of the master cylinder/booster. In block 506, a series regenerative braking mode and a pedal feel simulator of the HEV braking system are disabled. In block 508, the air gap filling head is extended into the air gap. In block 510, the master cylinder/booster push rod is extended into the master cylinder/booster through the pedal push rod and the air gap filling head upon braking of the HEV.

Although the embodiments of this disclosure have been described with respect to certain exemplary embodiments, it is to be understood that the specific embodiments are for purposes of illustration and not limitation, as other variations will occur to those of skill in the art.

What is claimed is:

1. A brake pedal simulator air gap filler system, comprising:
a brake pedal;
a pedal feel simulator engaged by said brake pedal;
a pedal push rod engaged by said brake pedal;
a master cylinder/booster push rod spaced-apart from said pedal push rod forming an air gap thereinbetween;
a master cylinder/booster engaged by said master cylinder/booster push rod; and
an air gap filling apparatus having an air gap filling head in adjacent proximity to said air gap and adapted to selectively engage and disengage said air gap.

2. The system of claim 1 wherein said air gap filling head is generally wedge-shaped.

3. The system of claim 1 wherein said air gap filling apparatus comprises a gap filling head actuator engaging said air gap filling head.

4. The system of claim 3 wherein said gap filling head actuator comprises a solenoid.

5. The system of claim 3 further comprising an actuator shaft extendable from said gap filling head actuator, and wherein said air gap filling head is carried by said actuator shaft.

6. The system of claim 1 further comprising an electric master cylinder push rod actuator engaging said master cylinder/booster push rod.

7. The system of claim 1 further comprising a brake pedal position sensor engaged by said brake pedal.

8. The system of claim 1 further comprising a brake pedal shaft and wherein said brake pedal is carried by said brake pedal shaft.

9. A brake pedal simulator air gap filler system, comprising:
an electronic control unit;
a brake pedal;
a pedal feel simulator engaged by said brake pedal and interfacing with said electronic control unit;
a pedal push rod engaged by said brake pedal;
a master cylinder/booster push rod spaced-apart from said pedal push rod;
an air gap between said pedal push rod and said master cylinder/booster push rod;
a master cylinder/booster engaged by said master cylinder/booster push rod and interfacing with said electronic control unit;
an air gap filling apparatus having an air gap filling head in adjacent proximity to said air gap and interfacing with said electronic control unit; and
said electronic control unit adapted to detect a condition affecting said master cylinder/booster and responsively inactivate said pedal feel simulator and cause engagement of said air gap filling head of said air gap filling apparatus with said air gap.

10. The system of claim 9 wherein said air gap filling head is generally wedge-shaped.

11. The system of claim 9 wherein said air gap filling apparatus comprises a gap filling head actuator engaging said air gap filling head and interfacing with said electronic control unit.

12. The system of claim 11 wherein said gap filling head actuator comprises a solenoid.

13. The system of claim 11 further comprising an actuator shaft extendable from said gap filling head actuator, and wherein said air gap filling head is carried by said actuator shaft.

14. The system of claim 9 further comprising an electric master cylinder push rod actuator engaging said master cylinder/booster push rod and interfacing with said electronic control unit.

15. The system of claim 9 further comprising a brake pedal position sensor engaged by said brake pedal and interfacing with said electronic control unit.

16. The system of claim 9 further comprising a brake pedal shaft and wherein said brake pedal is carried by said brake pedal shaft.

17. A method for operating an HEV brake pedal simulator equipped with an air gap filler, comprising the steps of:
positioning an air gap filling head in adjacent proximity to an air gap between a pedal push rod and a master cylinder/booster push rod of a hybrid electric vehicle braking system;
detecting a condition affecting a master cylinder/booster of said braking system;
disabling a series regenerative braking mode and a pedal feel simulator of said braking system;
extending said air gap filling head into said air gap; and
extending said master cylinder/booster push rod into a master cylinder/booster of said braking system through said pedal push rod and said air gap filling head.

18. The method of claim 17 wherein said detecting a condition affecting a master cylinder/booster of said braking system comprises detecting a cold condition.

19. The method of claim 17 further comprising inactivating a pedal feel simulator of the braking system.

20. The method of claim 17 wherein said positioning an air gap filling head in adjacent proximity to an air gap comprises positioning a generally wedge-shaped air gap filling head in adjacent proximity to said air gap.
